(19) United States
(12) Patent Application Publication
(10) Pub. No.: US 2012/0235603 A1
(43) Pub. Date: Sep. 20, 2012

(54) ACCELERATOR AND METHOD FOR ACTUATING AN ACCELERATOR

(76) Inventor: Oliver Heid, Erlangen (DE)

(21) Appl. No.: 13/499,881

(22) PCT Filed: Aug. 17, 2010
(86) PCT No.: PCT/EP2010/061935

§ 371 Date: May 24, 2012

(30) Foreign Application Priority Data
Oct. 2, 2009 (DE) 102009048150.8

(51) Int. Cl. H05H 7/02

(52) U.S. Cl. 315/505

(57) ABSTRACT

An accelerator for accelerating charged particles includes at least two RF resonators which are arranged successively in a beam propagation direction and configured to accelerate a pulse train comprising a plurality of particle bunches, each RF resonator generating an RF field, and a control apparatus for actuating the RF resonators, wherein the control apparatus is configured to set the RF fields generated by the RF resonators independently of one another during the acceleration of the pulse train, such that the plurality of particle bunches of the pulse train experience different accelerations during the acceleration of the pulse train. Further, a method for actuating an accelerator for accelerating charged particles having at least two RF resonators arranged successively in the beam propagation direction and with which a pulse train comprising a plurality of particle bunches is accelerated, includes, during the acceleration of the pulse train, independently controlling the RF fields generated by the at least two RF resonators such that the plurality of particle bunches of the pulse train experience different accelerations during the acceleration of the pulse train.

### CROSS-REFERENCE TO RELATED APPLICATIONS

This application is a U.S. National Stage Application of International Application No. PCT/EP2010/061935 filed Aug. 17, 2010, which designates the United States of America, and claims priority to DE Patent Application No. 10 2009 048 150.8 filed Oct. 2, 2009. The contents of which are hereby incorporated by reference in their entirety.

### TECHNICAL FIELD

This disclosure relates to an accelerator comprising at least two RF resonators and which is used to accelerate charged particles, and to a method for actuating such an accelerator. Such accelerators find use in various areas. Such accelerators can also in particular be used in irradiation methods in which the charged particles are accelerated, aimed at a target volume and deposit a dose in a defined region in the target volume.

### BACKGROUND

There are a large number of different accelerator structures for accelerating charged particles. In one specific type of accelerator, a beam of charged particles passes through what are referred to as RF resonators. The particles are accelerated when passing through the RF resonators owing to electromagnetic RF fields which are excited in the RF resonators, act on the particle beam and are tuned thereto.

The document “Beam acceleration in the single-gap resonator section of the UNILAC using alternating phase focusing” discloses for example a linear accelerator, arranged at the end section of which are 10 RF resonators in which the RF amplitude and the RF phase can be set independently of one another.

### SUMMARY

In one embodiment, an accelerator for accelerating charged particles includes at least two RF resonators which are arranged successively in the beam propagation direction and with which a pulse train comprising a plurality of particle bunches can be accelerated, and a control apparatus for actuating the RF resonators, wherein the RF fields, which are in each case generatable in the RF resonators, can be set during the acceleration of the pulse train independently of one another by the control apparatus such that during the acceleration of the pulse train the plurality of particle bunches of the pulse train experience different accelerations.

In a further embodiment, the control apparatus is configured such that during the acceleration of the pulse train a variable characterizing the RF field is varied for at least one of the RF resonators. In a further embodiment, the variable characterizing the RF field, which variable is varied during the acceleration of the pulse train, is an RF amplitude, an RF phase or an RF frequency of the RF field. In a further embodiment, the control apparatus is configured such that during the acceleration of the pulse train the relative RF phase between two of the at least two RF resonators is varied over time. In a further embodiment, the variation of the relative RF phase between the two RF resonators over time is generatable by setting a different RF frequency for the two RF resonators. In a further embodiment, the accelerator comprises more than two RF resonators and the accelerator has a non-periodic resonator structure. In a further embodiment, the individual RF resonators are electromagnetically decoupled from one another.

In another embodiment, a method is provided for actuating an accelerator for accelerating charged particles having at least two RF resonators which are arranged successively in the beam propagation direction and with which a pulse train comprising a plurality of particle bunches is accelerated, wherein the RF fields, which are in each case generatable in the RF resonators, are set independently of one another during the acceleration of the pulse train such that during the acceleration of the pulse train the plurality of particle bunches of the pulse train experience different accelerations.

In a further embodiment, during the acceleration of the pulse train a variable characterizing the RF field is varied for at least one of the RF resonators. In a further embodiment, the variable characterizing the RF field, which variable is varied during the acceleration of the pulse train, is an RF amplitude, an RF phase or an RF frequency of the RF field. In a further embodiment, during the acceleration of the pulse train the relative RF phase between two of the at least two RF resonators is varied over time. In a further embodiment, the variation of the relative RF phase between the two RF resonators over time is generated by setting a different RF frequency for the two RF resonators.

### BRIEF DESCRIPTION OF THE DRAWINGS

Example embodiments will be explained in more detail below with reference to figures, in which:

FIG. 1 shows the construction of an accelerator structure having a plurality of individually actuatable RF resonators, according to an example embodiment; and

FIG. 2 shows a flowchart of a method performed during the actuation of the accelerator during the acceleration of a pulse train, according to an example embodiment.

### DETAILED DESCRIPTION

Some embodiments provide an accelerator which enables effective and flexible acceleration of charged particles of different types, as well as a method for actuating such an accelerator.

In some embodiments, the accelerator for accelerating charged particles comprises at least two RF resonators which are arranged successively in the beam propagation direction and with which a pulse train comprising a plurality of particle bunches can be accelerated, and a control apparatus for actuating the RF resonators, wherein

the RF fields, which are in each case generatable in the RF resonators, can be set during the acceleration of the pulse train independently of one another by the control apparatus such that during the acceleration of the pulse train the plurality of particle bunches of the pulse train experience different accelerations.

The invention is based on the realization that, in conventional accelerators having RF resonators, a pulse train comprising a plurality of particle packets or particle bunches is accelerated such that the particle bunches substantially all experience the same acceleration. This is even advantageous for many applications, for example when the accelerated particle bunches are intended to be supplied to a further accelerator such as a synchrotron. However, it has been found that new opportunities of use emerge for an accelerator when the particle bunches are accelerated differently, so that the particles of a pulse train after acceleration have a plurality of energies rather than just one energy. In particular when irradiating a target volume, which is irradiated with the particle bunches of different energies, it is possible in this manner to very quickly cover a large depth region with one dose.

The different accelerations of the plurality of particle bunches in a pulse train are achieved by actuating the RF resonators individually during the acceleration of the pulse train. This means that the RF fields, which are coupled into the RF resonators, are set individually, that is to say independently of one another, with respect to their characteristics. This is achieved by feeding RF power via coupling-in structures in each case separately into the RF resonators, wherein the characteristic of the separately supplied RF power is individually controlled and/or set.

It has been recognized that this offers a decisive advantage over the RF resonators of a conventional n-stage accelerator, in which only one RF resonator is excited by an RF transmitter and in which the other RF resonators resonate owing to overcoupling of the RF field, for example by using the through-passage for the particle passage for overcoupling or by special coupling structures. Basically a standing wave forms in the longitudinal direction for the energy transport in the resonating RF resonators. For this reason, for example the respective phase difference between two of the successive RF resonators is only an integer multiple of 180°/N, with N designating the number of successive coupled RF resonators. This means a considerable limitation for the selection of the particle type to be used and of the end energy to be set. In addition, such an accelerator has the disadvantage that the desired oscillation mode and a balanced amplitude distribution —the amplitude decreases exponentially without correction measures with the distance from the feed resonator—are very difficult to attain, especially because the RF resonators have very high resonance Q factors for reasons of transmission power requirement. By way of example, the individual oscillation modes can have resonant frequencies which are very close together, as a result of which the desired oscillation mode is difficult to set and to stabilize. Frequently energy can flow into the near other, unusable resonance modes.

Many of these problems may be circumvented, however, with the accelerator as disclosed herein. The accelerator enables the RF field to be coupled in for each RF resonator and its acceleration section to be set separately. As a result, each RF resonator can be optimally tuned and set with respect to the passing particle packet. For each particle packet the best possible effect can unfold without the need to take into account the energy propagation of the RF fields between the RF resonators.

Because there is no need to take into account the energy propagation from RF resonator to RF resonator, the accelerator can be actuated in a very flexible manner. Different effects which have a disadvantageous effect on the acceleration of the particles can be balanced more easily. The pulse droop, i.e., the increase and decrease of the RF amplitude during a pulse train, for example owing to the transient response and/or the voltage drop of the power supply, can be compensated for. The longitudinal stability, i.e., the control of the effective E field over the particle packet length, can be attained more easily.

In addition, the choice of the end energy to be achieved of the particles is very flexible. For example, the particle energy can be set in particular independently of the RF amplitude, for example by changing the phase position in one or more RF resonators.

Another important resulting effect is that the RF power is no longer fed in at one location but distributed into the individual RF resonators, which results in a reduction of the power density in the coupling-in structure. Overall, it is possible in this manner to couple in a higher RF overall power in the accelerator and thus a higher accelerating RF field. By way of example, a more compact design can be attained with the same power.

In one embodiment, this can be achieved by configuring the control apparatus such that during the acceleration of the pulse train a variable characterizing the RF field is varied for one or more of the RF resonators. For example it is possible during the acceleration of the pulse train for the RF amplitude of the RF field, the RF frequency of the RF field or the RF phase of the RF field or any desired combination of these three variables to be varied. Since this is done during the acceleration of the pulse train, the individual particle bunches of the pulse train experience in each case a different acceleration when they pass through the RF resonator(s) in which the variable is varied.

In another embodiment, which can be implemented alternatively or additionally to the previously described embodiment, the different accelerations can also be achieved by the control apparatus during the acceleration of the pulse train varying over time the relative RF phase of the relative RF amplitude between two of the at least two RF resonators. In this embodiment, there is no absolute need to vary a variable characterizing the RF field during the acceleration in order to achieve the change in the relative RF phase. For example it is possible for RF fields with different RF frequencies to be induced in the two RF resonators. Owing to the different frequencies, however, a phase difference between the RF fields of these two RF resonators forms, which varies over time. As a result, for a fixed frequency difference the phase change is linear over time. During the acceleration of the pulse train, however, the setting of the respective RF fields can remain constant.

The individual RF resonators are electromagnetically decoupled from one another. The electromagnetic decoupling of the individual RF resonators can be achieved by means of different measures, for example by thick resonator walls, by long drift tubes with a small opening or by omission of specific RF couplers. The largely electromagnetically decoupled RF resonators are equipped in each case with a dedicated RF transmitter. The RF transmitters and thus the RF resonators are actuated with individual frequency, phase and amplitude. It thus becomes possible, for example, to vary the relative phases and amplitudes of the RF resonators during a pulse train.

In particular in accelerators for charged particles such as ions, which are intended to be accelerated to low-relativistic velocities or energies, the accelerator comprises more than two RF resonators, wherein the accelerator has a non-periodic resonator structure. The non-periodicity stems from the fact that the particle velocity increases significantly over the course of the acceleration. This means, for example, that the successively arranged RF resonators do not form a periodic structure, with the result that for example the distance between in each case two RF resonators changes in a non-periodic manner.

Such an accelerator can be realized relatively simply with individually actuatable RF resonators, as compared to accelerators in which a resonant energy propagation of the RF field between the RF resonators takes place. This is because the latter structure only allows for small freedoms with respect to additionally complying with further boundary conditions or making stipulations. This limits the flexibility during operation.

In some embodiments, an accelerator for accelerating charged particles having at least two RF resonators which are arranged successively in the beam propagation direction is actuated, wherein a pulse train comprising a plurality of particle bunches is accelerated. The RF fields, which are in each case generatable in the RF resonators, are set independently of one another during the acceleration of the pulse train such that during the acceleration of the pulse train the plurality of particle bunches of the pulse train experience different accelerations.

The explanations above and below regarding features, their mode of action and their advantages in each case relate to both the apparatus category and to the method category, without this being explicitly stated in each case. The individual features disclosed here can also be combined in other combinations than those shown.

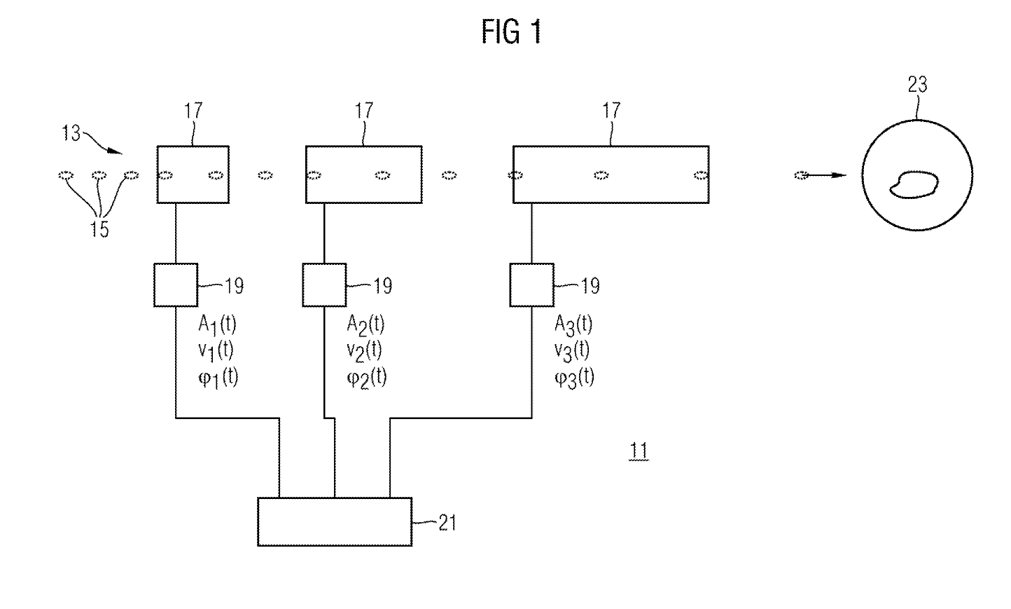

FIG. 1 shows, in a highly schematized illustration, an accelerator according to an example embodiment. FIG. 1 is used to explain the underlying principle and is therefore strongly simplified for reasons of clarity.

The accelerator 11 serves for the acceleration of a pulse train 13 of charged particles which comprises a plurality of particle bunches 15. The pulse train 13 is provided by a source (not illustrated here). The pulse train 13 is guided through RF resonators 17, in which the particle bunches 15 are in each case accelerated. The RF resonators 17 are electromagnetically decoupled from one another and are controllable independently of one another. To this end, assigned to each RF resonator 17 is an RF transmitter 19 which generates the accelerating RF field and couples it into the RF resonator 17. The RF transmitters 19 are controlled by a control unit 21, which includes a processor configured to execute computer-readable instructions stored in any suitable physical storage medium or media, for performing the various control functions disclosed herein.

In the example illustrated here, the greatest possible freedom in the actuation of the RF transmitters 19 and thus of the RF resonators 17 is shown, i.e. for each RF transmitter 19, the amplitude Aₓ, the phase φₓ and the frequency νₓ can be set individually, x=1 . . . 3. In addition, these variables Aₓ(t), φₓ(t), νₓ(t) are variable over time, i.e. they can be varied during the acceleration of the pulse train 13.

Such an embodiment is not absolutely necessary, however. It is also possible for some of these variables to be kept constant over time and they must not necessarily be set independently of one another. For example, the amplitude Aₓ(t)=A and the frequency νₓ(t)=ν can be kept constant and even be set to be identical in all RF resonators, and the result of the different acceleration of the individual particle bunches 15 can be obtained via a time-variable phase φₓ(t) in only a single one of the RF resonators 17.

Even an embodiment in which all variables are kept constant over time, Aₓ(t)=A, φₓ(t)=φ and νₓ(t)=ν, is possible. The result of obtaining a different acceleration of the individual particle bunches 15 can also be attained by setting the frequency νₓ of at least two of the RF resonators 17 to be different, for example ν₁≠ν₂.

The pulse train 13 accelerated by the accelerator 11 can be aimed at a target volume 23. Compared to a particle beam of uniform energy, the particle beam accelerated in this manner can deposit its dose in the target volume 23 in a greater depth region. The irradiation of different depths in the target volume 23 can thus be achieved very quickly and efficiently, which offers advantages for example when irradiating moving target volumes.

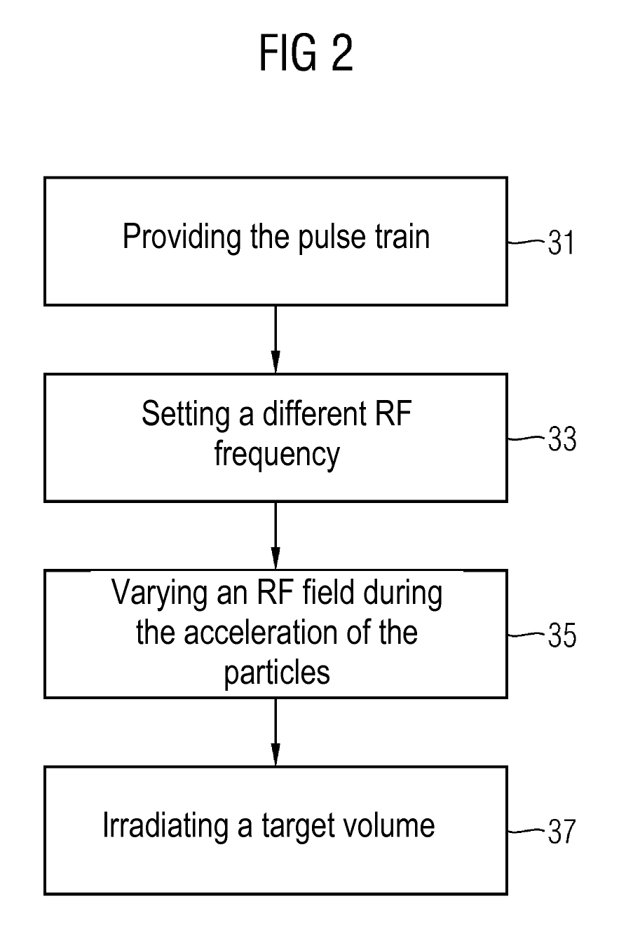

FIG. 2 shows a flowchart of an example method for actuating the accelerator during the acceleration of particles, according to an example embodiment.

First, a pulse train is made available, which comprises a plurality of particle bunches. The pulse train is guided through the accelerator unit (step 31).

During the acceleration of the pulse train, the RF resonators are controlled by control unit 21 such that in the case of at least two RF resonators a different RF frequency is set (step 33). As a result, the relative phase position of the RF resonators with respect to one another changes during the acceleration of the particles.

Alternatively and/or additionally, a variable characterizing the RF field can be varied over time by control unit 21 during the acceleration for at least one of the RF resonators (step 35).

Subsequently, the pulse train with the differently accelerated particle bunches is extracted from the accelerator and aimed at a target volume. The target volume is irradiated with the pulse train and the particle bunches contained therein (step 37).

### List of Elements Shown in the Figures:

11 Accelerator

13 Pulse Train

15 Particle Bunch

17 RF Resonator

19 RF Transmitter

21 Control Unit

23 Target Volume

31 Step 31

33 Step 33

35 Step 35

37 Step 37

What is claimed is:

1. An accelerator for accelerating charged particles, comprising:
at least two RF resonators which are arranged successively in a beam propagation direction and configured to accelerate a pulse train comprising a plurality of particle bunches, each RF resonator generating an RF field, and
a control apparatus for actuating the RF resonators, wherein the control apparatus is configured to set the RF fields generated by the RF resonators independently of one another during the acceleration of the pulse train, such that the plurality of particle bunches of the pulse train experience different accelerations during the acceleration of the pulse train.

2. The accelerator of claim 1, wherein the control apparatus is configured to vary a variable characterizing the RF field for at least one of the RF resonators, during the acceleration of the pulse train.

3. The accelerator of claim 2, wherein the variable characterizing the RF field, which variable is varied during the acceleration of the pulse train, is one of an RF amplitude, an RF phase, and an RF frequency of the RF field.

4. The accelerator of claim 1, wherein the control apparatus is configured to dynamically the relative RF phase between two of the at least two RF resonators during the acceleration of the pulse train.

5. The accelerator of claim 4, wherein the control apparatus is configured to vary the relative RF phase between the two RF resonators over time by setting a different RF frequency for the two RF resonators.

6. The accelerator of claim 1, wherein the accelerator comprises more than two RF resonators and the accelerator has a non-periodic resonator structure.

7. The accelerator of claim 1, wherein the individual RF resonators are electromagnetically decoupled from one another.

8. A method for actuating an accelerator for accelerating charged particles having at least two RF resonators arranged successively in the beam propagation direction and with which a pulse train comprising a plurality of particle bunches is accelerated, the method comprising:
during the acceleration of the pulse train, independently controlling the RF fields generated by the at least two RF resonators such that the plurality of particle bunches of the pulse train experience different accelerations during the acceleration of the pulse train.

9. The method of claim 8, comprising varying a variable characterizing the RF field for at least one of the RF resonators during the acceleration of the pulse train.

10. The method of claim 9, wherein the variable characterizing the RF field, which variable is varied during the acceleration of the pulse train, is one of an RF amplitude, an RF phase, and an RF frequency of the RF field.

11. The method of claim 8, comprising dynamically varying the relative RF phase between two of the at least two RF resonators during the acceleration of the pulse train.

12. The method of claim 11, the relative RF phase between the two RF resonators is dynamically varied by setting a different RF frequency for the two RF resonators.
